(19) United States
(12) Patent Application Publication
(10) Pub. No.: US 2003/0070309 A1
(43) Pub. Date: Apr. 17, 2003

(54) Handles for personal care products

(76) Inventors: William R. Brown, Peabody, MA (US); Daniel C. Portman, South Attleboro, MA (US); Helge Zimmet, Waltham, MA (US)

Correspondence Address: FISH & RICHARDSON PC, 225 FRANKLIN ST, BOSTON, MA, 02110, US

(21) Appl. No.: 09/977,431

(22) Filed: Oct. 15, 2001

(51) Int. Cl. B26B 21/52

(52) U.S. Cl. 30/535

(57) ABSTRACT

Handles for personal care products are provided having a sheath/core construction. Methods are provided for manufacturing such handles.

### TECHNICAL FIELD

This invention relates to handles for personal care products.

### BACKGROUND

Razor handles are typically a certain weight to give a desired feel to a user, both for comfort and a perception of quality. Traditionally, the handle is made of metal to accomplish the weight and feel.

Further, razor handles generally should have certain tactile properties, such as comfort and slip resistance, which may be provided by, e.g., an elastomeric grip.

Many razor handles today are generally made from polymers, particularly disposable razors. However, polymers alone are relatively light when compared to the traditional metal handles. In some cases a filler material is mixed with the polymer to make the polymer denser. Generally, the filler would be a metal, such as copper, iron or tungsten. However, adding metal fillers tends to make the handle brittle, thereby reducing impact resistance. Typically, the higher the percentage of filler, the more brittle the handle becomes. Further, metallic fillers are generally dark and, therefore, a metal filled polymer compound is difficult or impossible to color. Also, a polymer with a metal filler may not have the desired tactile properties.

### SUMMARY

The invention features handles for personal care products that include a core of a polymer containing filler and a sheath of a thermoplastic polymer or an elastomeric material. The core gives the handle its desired weight and rigidity. The sheath provides impact resistance and the desired tactile properties, such as slip resistance and softness. The impact resistance imparted by the sheath also allows for a higher percentage of filler to be added to the core to get the desired weight. Further, the sheath allows the handle to be almost any color.

In some implementations, the sheath/core combination allows the core to be made from a less expensive polymer, since the sheath provides the mechanical properties. Also, the filler can be relatively inexpensive since the percentage of filler can be increased and thus lower density fillers can be used to obtain the same weight.

In one aspect, the invention features a personal care product handle that includes a core and a sheath surrounding the core, where the core has a density greater than the sheath.

Preferred embodiments include one or more of the following features. The core is a polymer combined with a filler. The filler is a metallic material. The metallic filler can be copper, iron, zinc, aluminum or tungsten. The polymer of the core can be polypropylene, nylon, acrylonitrile butadiene styrene, polybutylene terephthalate, polyurethane, polyphenylenesulfide, polyetheretherketone, polystyrene, polyethylene, or polyphenylene oxide. The sheath is either an elastomeric material or a thermoplastic polymer. The elastomeric material of the sheath can be thermoplastic vulcanates (rubber polyolefin blends), polyetheramides, polyesters, styrene-ethylene-butylene-styrene (SEBS) block copolymers, styrene-butadiene-styrene block copolymers (SBS), partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof, closed cell foams, resilient urethanes and silicones. The thermoplastic polymer of the sheath can be polypropylene, nylon, acrylonitrile butadiene styrene, polybutylene terephthalate, polyurethane, polyphenylenesulfide, polyetheretherketone, polystyrene, high impact polystyrene, or polyphenylene oxide. The sheath hardness is preferably 25 Shore A to 130 Rockwell R, more preferably 50 Shore A to 100 Rockwell R, and most preferably 60 Shore A to 90 Rockwell R. The sheath is preferably 0.5 mm to 3.0 mm thick, more preferably 0.7 mm to 2.0 mm thick and most preferably 0.7 mm to 1.0 mm thick.

In one aspect of the invention, the personal care product handle is a razor handle. In another aspect of the invention, the personal care product handle is a toothbrush handle.

Other aspects of the invention may include the filler having a density of approximately 2.0 to 20.0 g/cm³, more preferably 10.0 to 20.0 g/cm³. The core is approximately 10 to 80% filler by volume, more preferably 40 to 60% filler by volume. The core has a density of approximately 2.0 to 11.0 g/cm³, more preferably 6.0 to 11.0 g/cm³. The sheath has a density of approximately 0.8 to 2.0 g/cm³, more preferably 1.0 to 1.5 g/cm³. The sheath is approximately 30 to 80% of the volume of the handle, more preferably 45 to 60% and most preferably 45 to 50%. The sheath is slip resistant. The sheath is impact resistant.

A further aspect of the invention includes a razor handle having a polymeric core surrounded by an elastomeric sheath, wherein the polymeric core has a density greater than the elastomeric sheath. The core can further include a filler. The filler can be a metallic filler. The razor handle can include a portion of the polymeric core exposed through the sheath. The exposed portion of the polymeric core defines a connection point for a razor cartridge.

Another aspect of the invention features methods of making the above described products. One method includes forming a core and forming a sheath around the core. In a preferred embodiment the core has a density greater than the sheath, and the core and sheath are formed by a sandwich-molding process.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a razor according to one embodiment of the invention.

FIG. 2 is a cross-sectional view of the razor of FIG. 1.

FIG. 3 is a cross-sectional view of the razor of FIG. 2 taken along line 3-3 in FIG. 2.

FIG. 4 is a cross-sectional view of a mold used to make the razor of FIG. 1.

FIG. 5 is a cross-sectional view of the mold of FIG. 4 with a shot of sheath material entering the cavity.

FIG. 6 is a cross-sectional view of the mold of FIG. 5 with a shot of core material entering the cavity.

FIG. 7 is a cross-sectional view of the mold of FIG. 6 with a final shot of sheath material entering the cavity.

FIG. 8 is a cross-sectional view of a razor according to an alternate embodiment of the invention.

FIG. 9 is a cross-sectional view of a razor according to another alternate embodiment of the invention.

### DETAILED DESCRIPTION

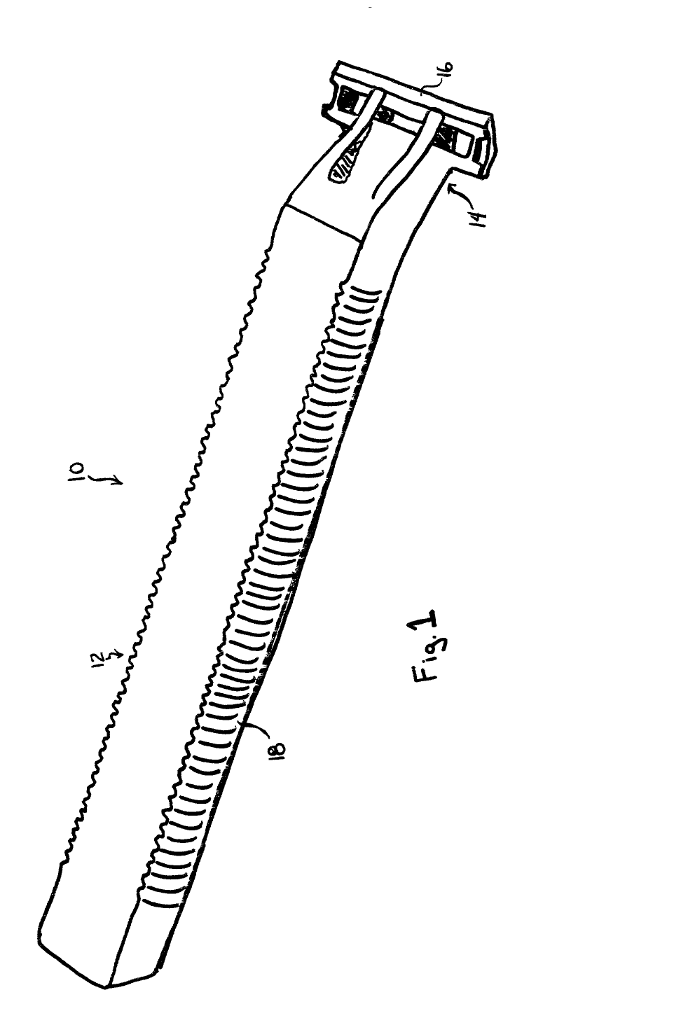

Referring to FIG. 1, a razor 10 includes a handle 12 and a head portion 14. A razor blade cartridge 16 is mounted to the head portion 14. The handle 12 has a grip 18 that provides comfort for the user and a non-slip surface to prevent the handle 12 from slipping from the user's hand.

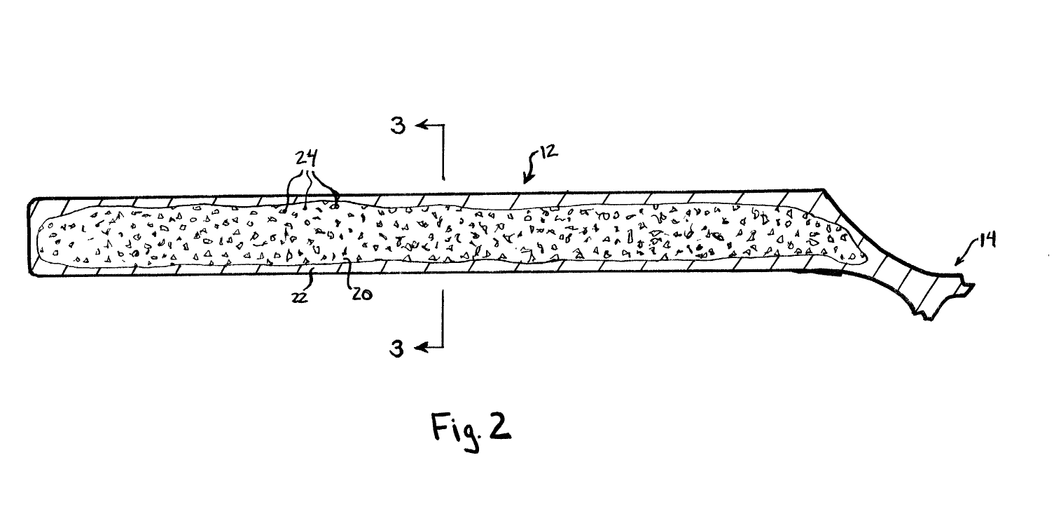

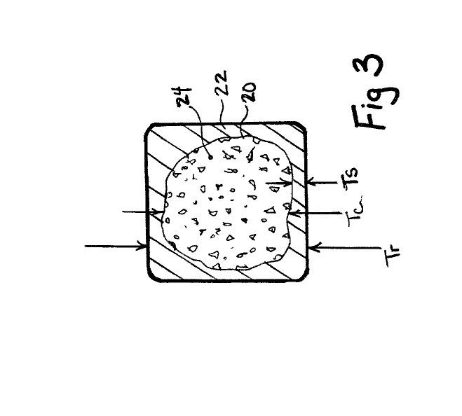

Referring to FIGS. 2 and 3, the handle 12 includes a core 20 enclosed in a sheath 22. The core is generally formed of a polymer loaded with filler 24. The sheath is generally formed of an unfilled polymer. The grip 18 can either be contours molded into the sheath 22 or soft grips of thermoplastic elastomers molded onto the handle 12.

The core 20 and sheath 22 will be formed such that the sheath 22 is a thin layer around the core 20. For example, the sheath 22 at its thinnest point, Ts, is preferably 0.5 to 3.0 mm thick, more preferably 0.7 to 2.0 mm, and most preferably 0.7 to 1.0 mm. The thickness of the core will depend on the design and size of the razor 10. For a typical example, the GoodNews™ disposable razor (depicted in the figures) will have a core at its thickest point, Tc, of approximately 0.5 to 2.5 mm, more preferably 0.6 to 2.0 mm, and most preferably 0.6 to 1.5 mm. The thickness or diameter of the overall razor, Tr, is generally 8 to 10 mm.

The core 20 is generally a polymer filled with a metallic filler. Examples of possible core polymers include, but are not limited to, polypropylene, nylon, acrylonitrile butadiene styrene, polybutylene terephthalate, polyurethane, polyphenylenesulfide, polyetheretherketone, polystyrene, polyethylene, and polyphenylene oxide. The present invention allows for the utilization of an inexpensive polymer that can be sandwich molded with a chosen sheath material, as described below.

The filler is chosen to increase the density of the core polymer. Suitable fillers include, but are not limited to, copper, iron, zinc, aluminum and tungsten.

Preferred sheath materials will have good impact resistant qualities because the sheath will provide the impact resistance for the core 20, which may be brittle due to the filler. The sheath can also be chosen to provide slip resistance. Suitable sheath materials include thermoplastic elastomers, such as SBS copolymers, thermoplastic vulcanates (rubber polyolefin blends), polyetheramides, polyesters, styrene-ethylene-butylene-styrene (SEBS) block copolymers, styrene-butadiene-styrene block copolymers, partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof, closed cell foams, resilient urethanes and silicones. Other suitable sheath materials include thermoplastic polymers such as polypropylene, nylon, acrylonitrile butadiene styrene, polybutylene terephthalate, polyurethane, polyphenylenesulfide, polyetheretherketone, polystyrene, high impact polystyrene, and polyphenylene oxide. The sheath will generally have a hardness of approximately 25 Shore A to 130 Rockwell R, more preferably 50 Shore A to 100 Rockwell R, and most preferably 60 Shore A to 90 Rockwell R.

In general, the percent volume of sheath material, in relation to the total core and sheath material, is approximately 30 to 80%, more preferably 45 to 60%, and most preferably 45 to 50%. The percent volume may vary depending on the particular materials chosen.

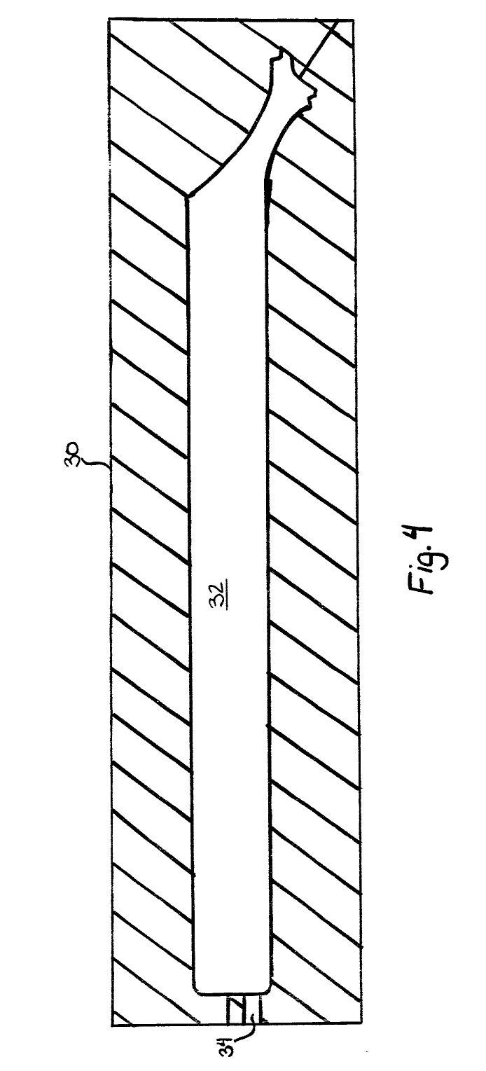

Referring to FIGS. 4-7, the handle may be formed by a sandwich-molding process. The mold 30, shown in FIG. 4, has a cavity 32 shaped like the finished razor handle 10. A gate 34 leads into the cavity 32, allowing the sheath and core materials to be injected into the mold cavity 32.

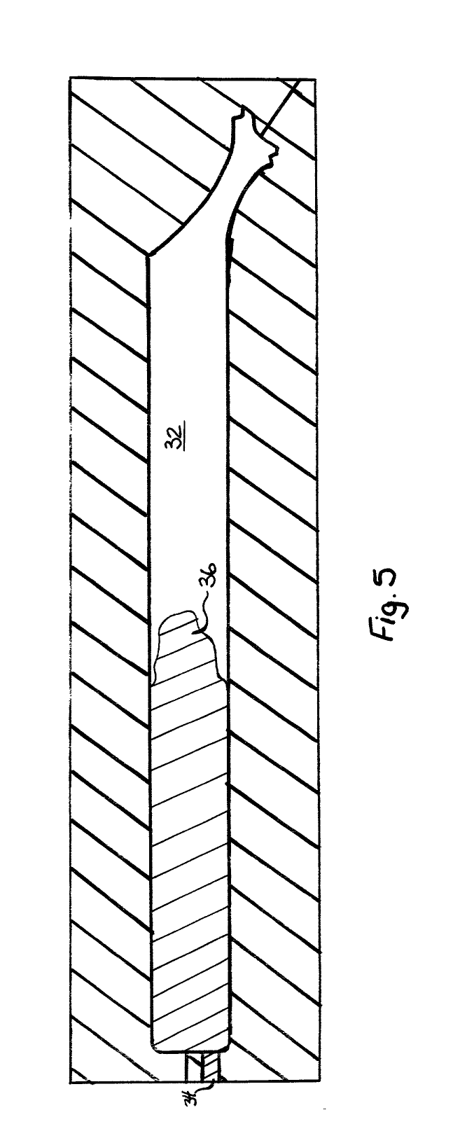

A shot of sheath material 36 is injected into the cavity 32 via the gate 34 to start forming the sheath 22 of the razor handle 10, as shown in FIG. 5. The amount injected is calculated to provide a sheath with the desired thickness when the core material is injected into it. A minimum thickness is necessary to prevent the core material from breaking through the sheath. For example, a minimum of 40% by volume of sheath material 36 is generally suitable to prevent break-though when using a nylon-6 polymer, commercially available from RTP under the trade name RTP 299 AX 857673 B, as the core material. As is common with sandwich-molding techniques, as the melted sheath material 36 enters the mold cavity, it comes into contact with the cooled walls of the mold cavity and begins to cool, thereby increasing its viscosity.

When choosing the sheath and core polymers for a particular application, several physical parameters should be considered. First, the two polymers preferably have similar melt temperatures. If the process melt temperatures of the two polymers are very different, the polymer with the lower melt temperature might not be able to stand the higher processing temperature necessary to process the other polymer without degradation.

Second, the melt viscosities of the two polymers at process temperature can be similar or different. However, the viscosity of the sheath polymer at process temperature generally should not be less than 45% of the viscosity of the core polymer at process temperature. The lower the sheath polymer viscosity relative to the core polymer viscosity, the more likely it is that the core will break through the sheath or cause swirl marks in the sheath from mixed sheath and core polymers. However, in applications where swirl marks may be aesthetically desirable, the sheath polymer can be chosen with a viscosity less than 45% below that of the core polymer to produce the swirl marks.

Finally, the sheath polymer is chosen to adhere to the core polymer, providing better part integrity. Also, if elastomeric grips 18 are to be overmolded onto the sheath 22, the sheath polymer should be chosen to allow the elastomeric grips to adhere to the sheath 22.

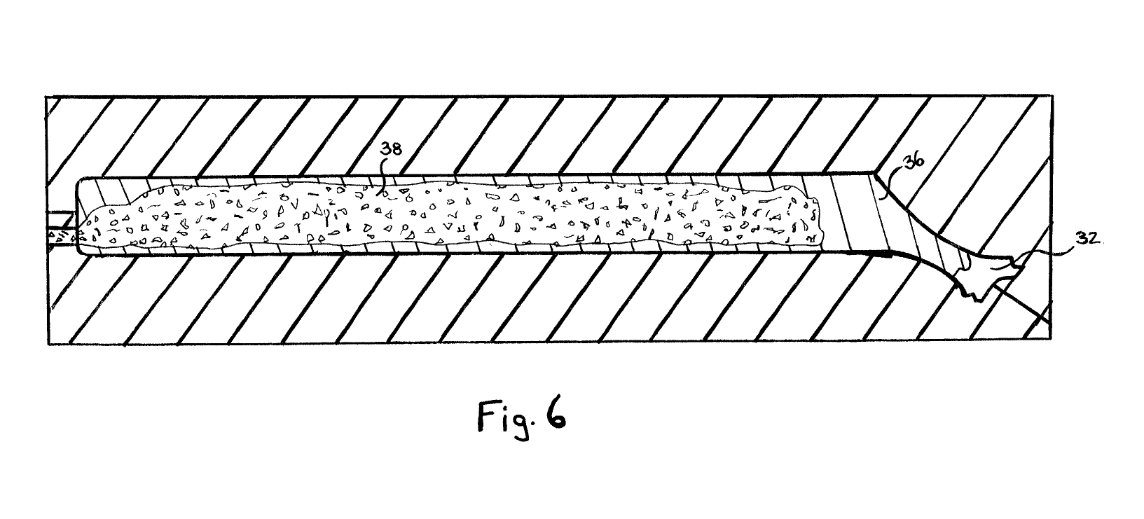

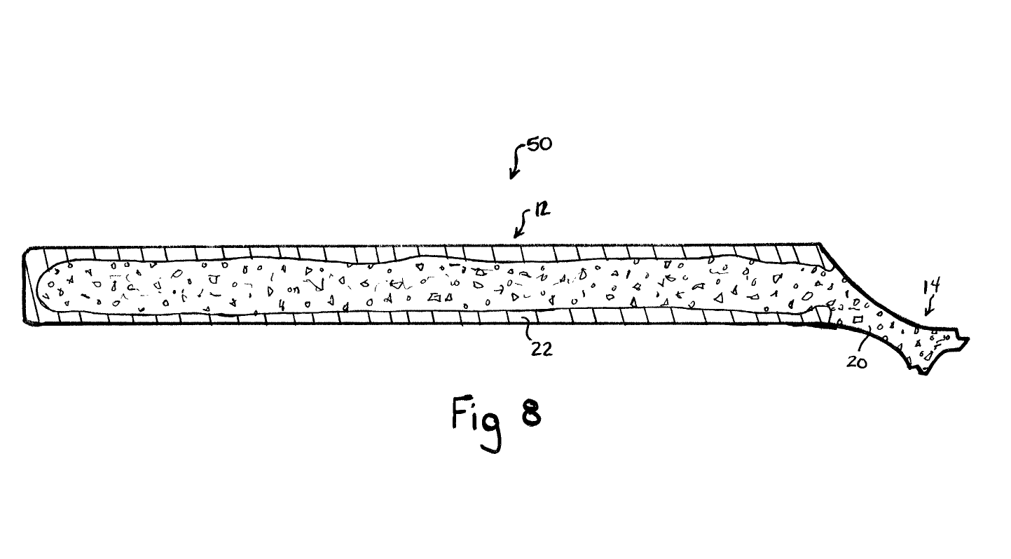

A shot of core material 38 is then injected into the center of the sheath material 36 through the same gate 34, thereby filling and expanding the sheath material 36 to the shape of the mold (FIG. 6). The amount of core material 38 injected will depend on the final thickness of the handle 12. A sufficient amount will be injected to expand the sheath material and almost fill the mold cavity 32 defining the handle 12, leaving room for a final shot of sheath material. However, care should be taken not to inject an amount of core material 38 that would completely fill the mold cavity and possibly break through the sheath 22, unless this is desirable, as described below with reference to FIG. 8.

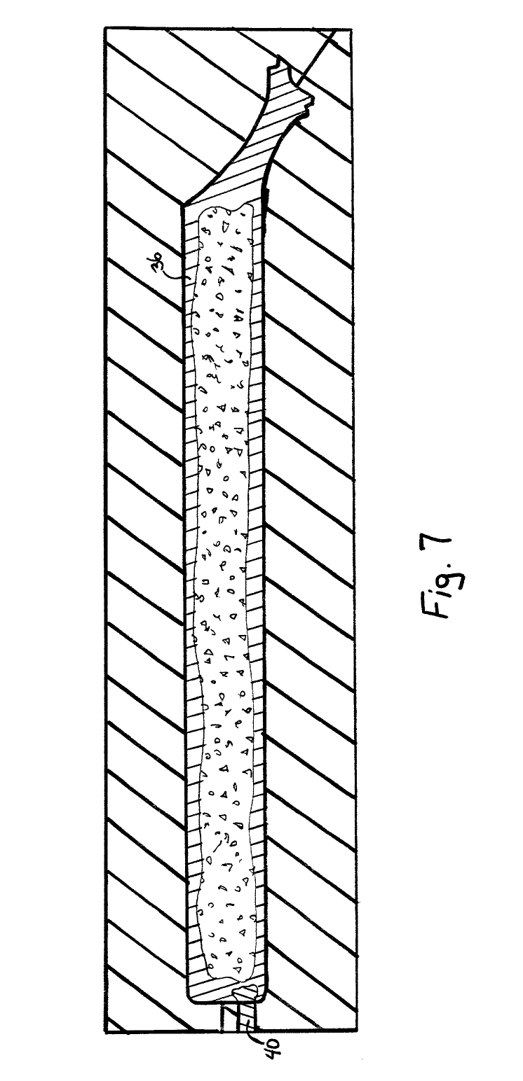

Finally, a small shot of sheath material 40 is injected through the gate 34 to seal off the core material (FIG. 7). The final shot of material 40 gives the finished handle a clean look. If the final shot of sheath material 40 is not injected, a small amount of core material 38 will poke through the sheath at the gate location.

A number of embodiments of the invention have been described. Nevertheless, it will be understood that various modifications may be made without departing from the spirit and scope of the invention.

For example, a foaming agent may also be added to the core to reduce sink marks in the sheath. The foaming agent will cause the core to expand further than it would without the foaming agent and, therefore, push the sheath material outward against the mold. This will prevent the sheath from having sink marks or depressions on the surface of the handle by compensating for the volumetric shrinkage of the core polymer melt as it cools, assuring that the sheath has a surface finish with little or no defects. The foaming agent causes bubbles in the core polymer, but the sheath hides the bubbles that occur.

Further, the amount of sheath material may be calculated to allow the core material to break through. As shown in FIG. 8, the core 20 is allowed to break through the sheath 22 to form the head 14 of the razor 50 where a razor blade cartridge would be attached. On a toothbrush, the core can be allowed to break through to form the head where the bristles attach.

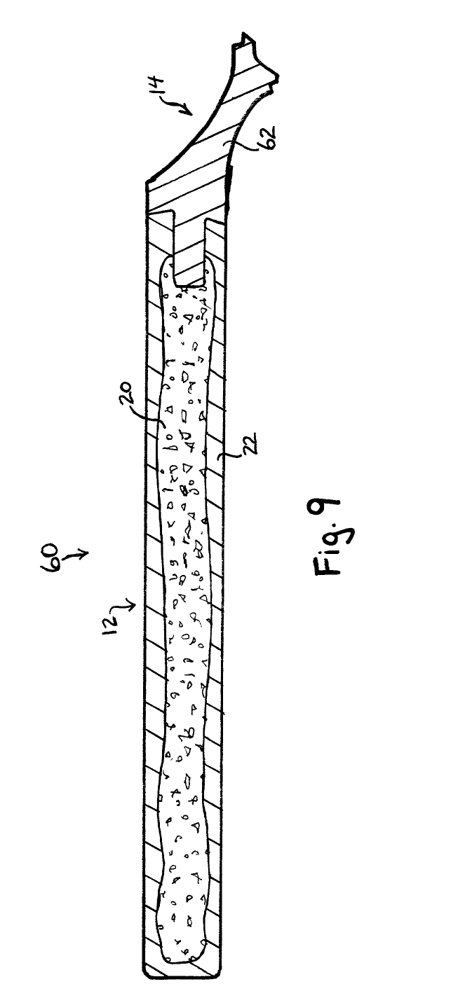

As shown in FIG. 9, the head 14 may be a separate head portion 62. This allows for a third material to be used for the head 14, allowing for different mechanical properties or colors on the head portion. The handle 12 can be molded around the head portion 62, allowing the core 20 and sheath 22 to bond to the head portion 62. The head portion 62 is molded in a separate molding operation, and then placed in a mold to allow the handle 12 to be sandwich molded around the head portion 62.

Moreover, the sheath may include a small amount of filler. For example, the sheath may include fillers other than the metal fillers described here, such as fillers added for aesthetic or manufacturing purposes.

Further, handles for products other than personal care products that require weight and impact resistance may be made according to the present invention. Accordingly, other embodiments are within the scope of the following claims.

### EXAMPLES

An example of a GoodNews™ razor handle made according to the invention included a sheath of high impact polystyrene, which has a density of approximately 1.05 g/cm³. The core was a nylon-6 filled with tungsten, which is manufactured by RTP under the trade name RTP 299 AX 857673 B. The density of the nylon-6 polymer is approximately 1.1 g/cm³. The core polymer was filled with tungsten to deliver a compound with a density of approximately 4.9 g/cm³. The resulting razor handle had a weight of approximately 13 g. As a comparison, the same part made of polypropylene alone, which has a density of 0.9 g/cm³, had a weight of only 6 g. The sheath was about 1.0 mm thick on a handle that is 9.0×9.0 mm square, and the core was not allowed to break through the sheath.

Another example of a GoodNews™ razor handle made according to the invention included a sheath of thermoplastic elastomer compound available from Kraiburg under the trade name STO 7958/20, which has a density of approximately 1 g/cm³. The core was again the RTP nylon-6 based compound (RTP 299 AX 857673 B) with tungsten as a filler, as described above. Five percent by weight of a chemical foaming agent, available from Clariant under the trade name Activex 861, was added to the core composition to compensate for core material shrinkage and avoid sink marks. The resulting razor handle had a weight of approximately 18 g. The core was allowed to break through at the end so that the head of the razor is not covered by the sheath, as shown in FIG. 8.

What is claimed is:

1. A personal care product handle comprising:
(a) a core; and
(b) a sheath surrounding the core, the core having a density greater than the sheath.

2. The personal care product handle of claim 1 wherein the core comprises a polymer combined with a filler.

3. The personal care product handle of claim 2 wherein the filler is a metallic material.

4. The personal care product handle of claim 3 wherein the metallic material is selected from the group consisting of copper, iron, zinc, aluminum or tungsten.

5. The personal care product handle of claim 2 wherein the polymer is selected from the group consisting of polypropylene, nylon, acrylonitrile butadiene styrene, polybutylene terephthalate, polyurethane, polyphenylenesulfide, polyetheretherketone, polystyrene, polyethylene, and polyphenylene oxide.

6. The personal care product handle of claim 1 wherein the sheath is an elastomeric material.

7. The personal care product handle of claim 6 wherein the elastomeric material is selected from the group consisting of thermoplastic vulcanates (rubber polyolefin blends), polyetheramides, polyesters, styrene-ethylene-butylene-styrene (SEBS) block copolymers, styrene-butadiene-styrene block copolymers (SBS), partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof, closed cell foams, resilient urethanes and silicones.

8. The personal care product handle of claim 1 wherein the sheath is a thermoplastic polymer.

9. The personal care product handle of claim 8 wherein the thermoplastic polymer is selected from the group consisting of polypropylene, nylon, acrylonitrile butadiene styrene, polybutylene terephthalate, polyurethane, polyphenylenesulfide, polyetheretherketone, polystyrene, high impact polystyrene, and polyphenylene oxide.

10. The personal care product handle of claim 1 wherein the sheath has a hardness of approximately 25 Shore A to 130 Rockwell R.

11. The personal care product handle of claim 10 wherein the sheath has a hardness of approximately 50 Shore A to 100 Rockwell R.

12. The personal care product handle of claim 11 wherein the sheath has a hardness of approximately 60 Shore A to 90 Rockwell R.

13. The personal care product handle of claim 1 wherein the sheath is approximately 0.5 mm to 3.0 mm thick.

14. The personal care product handle of claim 13 wherein the sheath is approximately 0.7 mm to 2.0 mm thick.

15. The personal care product handle of claim 14 wherein the sheath is approximately 0.7 mm to 1.0 mm thick

16. The personal care product handle of claim 1 wherein the handle is a razor handle.

17. The personal care product handle of claim 1 wherein the handle is a toothbrush handle.

18. The personal care product handle of claim 2 wherein the filler has a density of approximately 2.0 to 20.0 g/cm³.

19. The personal care product handle of claim 18 wherein the filler has a density of approximately 10.0 to 20.0 g/cm³.

20. The personal care product handle of claim 2 wherein core includes approximately 10 to 80% filler by volume.

21. The personal care product handle of claim 20 wherein core includes approximately 40 to 60% filler by volume.

22. The personal care product handle of claim 1 wherein the core has a density of approximately 2.0 to 11.0 g/cm³.

23. The personal care product handle of claim 22 wherein the core has a density of approximately 6.0 to 11.0 g/cm³.

24. The personal care product handle of claim 1 wherein the sheath has a density of approximately 0.8 to 2.0 g/cm³.

25. The personal care product handle of claim 24 wherein the sheath has a density of approximately 1.0 to 1.5 g/cm³.

26. The personal care product handle of claim 1 wherein the sheath comprises approximately 30 to 80% of the volume of the handle.

27. The personal care product handle of claim 26 wherein the sheath comprises approximately 45 to 60% of the volume of the handle.

28. The personal care product handle of claim 27 wherein the sheath comprises approximately 45 to 50% of the volume of the handle.

29. The personal care product handle of claim 2 wherein the filler is selected from the group consisting of cooper, iron, zinc, aluminum and tungsten.

30. The personal care product handle of claim 1 wherein the sheath is slip resistant.

31. The personal care product handle of claim 1 wherein the sheath is impact resistant.

32. A razor handle comprising:
(a) a polymeric core; and
(b) an elastomeric sheath surrounding the polymeric core, wherein the polymeric core has a density greater then the elastomeric sheath.

33. The razor handle of claim 32 wherein the polymeric core further comprises a filler.

34. The razor handle of claim 33 wherein the filler is a metallic filler.

35. The razor handle of claim 32 wherein the razor handle further comprises a portion in which the polymeric core is exposed through the sheath material.

36. The razor handle of claim 35 wherein the exposed core portion defines a connection point for a razor cartridge.

37. A razor handle comprising:
(a) a polymeric core; and
(b) a thermoplastic sheath surrounding the polymeric core, wherein the polymeric core has a density greater then the thermoplastic sheath.

38. The razor handle of claim 37 wherein the polymeric core further comprises a filler.

39. The razor handle of claim 38 wherein the filler is a metallic filler.

40. The razor handle of claim 37 wherein the razor handle further comprises a portion in which the polymeric core is exposed through the thermoplastic sheath.

41. The razor handle of claim 40 wherein the exposed core portion defines a connection point for a razor cartridge.

42. A razor handle comprising:
(a) a polymeric core; and
(b) an elastomeric sheath surrounding the polymeric core, wherein the polymeric core is exposed through a portion of the elastomeric sheath.

43. A razor handle comprising:
(a) a polymeric core; and
(b) a thermoplastic sheath surrounding the polymeric core, wherein the polymeric core is exposed through a portion of the thermoplastic sheath.

44. A method of manufacturing a personal care product handle comprising:
(a) forming a core; and
(b) forming a sheath around the core, the core having a density greater than the sheath.

45. The method of claim 44 wherein the core comprises a polymer containing a filler.

46. The method of claim 45 wherein the filler is a metallic material.

47. The method of claim 46 wherein the metallic material is selected from the group consisting of cooper, iron, zinc, aluminum and tungsten.

48. The method of claim 45 wherein the polymer is selected from the group consisting of polypropylene, nylon, acrylonitrile butadiene styrene, polybutylene terephthalate, polyurethane, polyphenylenesulfide, polyetheretherketone, polystyrene, polyethylene, and polyphenylene oxide.

49. The method of claim 44 wherein the sheath is an elastomeric material.

50. The method of claim 49 wherein the elastomeric material is selected from the group consisting of thermoplastic vulcanates (rubber polyolefin blends), polyetheramides, polyesters, styrene-ethylene-butylene-styrene (SEBS) block copolymers, styrene-butadiene-styrene block copolymers (SBS), partially or fully hydrogenated styrene-butadiene-styrene block copolymers, styrene-isoprene-styrene block copolymers, polyurethanes, polyolefin elastomers, polyolefin plastomers, styrenic based polyolefin elastomers, and compatible mixtures thereof, closed cell foams, resilient urethanes and silicones.

51. The method of claim 44 wherein the sheath is a thermoplastic polymer.

52. The method of claim 51 wherein the thermoplastic polymer is selected from the group consisting of polypropylene, nylon, acrylonitrile butadiene styrene, polybutylene terephthalate, polyurethane, polyphenylenesulfide, polyetheretherketone, polystyrene, high impact polystyrene, and polyphenylene oxide.

53. The method of claim 44 wherein the sheath has a hardness of approximately 25 Shore A to 130 Rockwell R.

54. The method of claim 53 wherein the sheath has a hardness of approximately 50 Shore A to 100 Rockwell R.

55. The method of claim 54 wherein the sheath has a hardness of approximately 60 Shore A to 90 Rockwell R.

56. The method of claim 44 wherein the sheath is approximately 0.7 mm to 2.0 mm thick.

57. The method of claim 56 wherein the sheath is approximately 0.7 mm to 1.0 mm thick.

58. The method of claim 44 wherein the handle is a razor handle.

59. The method of claim 44 wherein the handle is a toothbrush handle.

60. The method of claim 45 wherein the filler has a density of approximately 2.0 to 20.0 g/cm³.

61. The method of claim 60 wherein the filler has a density of approximately 10.0 to 20.0 g/cm³.

62. The method of claim 45 wherein core includes approximately 10 to 80% filler by volume.

63. The method of claim 62 wherein core includes approximately 40 to 60% filler by volume.

64. The method of claim 44 wherein the core has a density of approximately 2.0 to 11.0 g/cm³.

65. The method of claim 64 wherein the core has a density of approximately 6.0 to 11.0 g/cm³.

66. The method of claim 44 wherein the sheath has a density of approximately 0.8 to 2.0 g/cm³.

67. The method of claim 66 wherein the sheath has a density of approximately 1.0 to 1.5 g/cm³.

68. The method of claim 44 wherein the sheath comprises approximately 30 to 80% of the volume of the handle.

69. The method of claim 68 wherein the sheath comprises approximately 45 to 60% of the volume of the handle.

70. The method of claim 69 wherein the sheath comprises approximately 45 to 50% of the volume of the handle.

71. The method of claim 44 wherein the core and the sheath are formed using a sandwich-molding process.

72. The method of claim 44 wherein a portion of the core is exposed through a portion of the sheath material.

73. A method of manufacturing a personal care product comprising:
(a) forming a handle on a preformed head portion;
(b) the handle comprising a core and a sheath around the core, the core having a density greater than the sheath.

74. The method of claim 73 wherein the personal care product is a toothbrush.

75. The method of claim 73 wherein the personal care product is a razor.
